(19) United States
(12) Patent Application Publication
(10) Pub. No.: US 2012/0172059 A1
(43) Pub. Date: Jul. 5, 2012

(54) MOBILE SYSTEM FOR AUTOMATICALLY RECOMMENDING CONTENTS, CONTENT RECOMMENDATION SYSTEM, AND CONTENT RECOMMENDATION METHOD

(75) Inventors: Gi Bum Kim, Seongnam-si (KR); Seung Kil Choi, Incheon Metropolitan City (KR); Chang Ho Kim, Seoul (KR)

(73) Assignee: NHN CORPORATION, Seongnam-si (KR)

(21) Appl. No.: 13/173,259

(22) Filed: Jun. 30, 2011

(30) Foreign Application Priority Data
Jun. 30, 2010 (KR) 10-2010-0062890

(51) Int. Cl. H04W 4/02

(52) U.S. Cl. 455/456.3

(57) ABSTRACT

Provided are a mobile system for automatically recommending contents, a content recommendation system, and a content recommendation method. The mobile system may include a communication unit to receive playlist information of another user based on at least one of a current position and a position set by a user, and a content recommendation unit to recommend at least one content based on the received playlist information.

### CROSS REFERENCE TO RELATED APPLICATION

This application claims priority from and the benefit of Korean Patent Application No. 10-2010-0062890, filed on Jun. 30, 2010, in the Korean Intellectual Property Office, the disclosure of which is incorporated by reference for all purposes as if fully set forth herein.

### BACKGROUND OF THE INVENTION

1. Field of the Invention

Exemplary embodiments of the present invention relate to a mobile system for automatically recommending contents, a content recommendation system, and a content recommendation method.

2. Description of the Background

With search fields playing a large role in the existing internet market, a large number of services are entwined with particular focus on search portals. As focus shifts from the search field in the internet to a mobile field, expectation for mobile search capability has increased accordingly. In a mobile search field, unlike the existing internet search field, a position of a user may constantly change and more services may be provided using the position of the user.

There is, therefore, a demand for a system and method that may effectively recommend contents based upon the position of a user.

### SUMMARY OF THE INVENTION

Exemplary embodiments of the present invention relate to a mobile system for automatically recommending contents, a content recommendation system, and a content recommendation method.

Additional features of the invention will be set forth in the description which follows, and in part will be apparent from the description, or may be learned by practice of the invention.

Exemplary embodiments of the present invention provide a mobile system including a communication unit to receive first playlist information based on at least one position of a current position of the mobile system and a set position, and a content recommendation unit to recommend contents based on the received first play information.

Exemplary embodiments of present invention also provide a mobile system including a communication unit and a content recommendation unit. The communication unit transmits information about at least one position of a current position of the mobile system and a set position to a content recommendation server, and receives recommendation information from the content recommendation server. The content recommendation unit recommends at least one content based on the recommendation information. The recommendation information is provided by the content recommendation server based on playlist information of another mobile system in a region corresponding to the at least one position.

Exemplary embodiment of present invention also provide a content recommendation system including a request receiving unit, a playlist information receiving unit, a content selection unit, and a recommendation information transmission unit. The request receiving unit receives a content recommendation request including position information from a first mobile terminal. The playlist information receiving unit receives playlist information from at least one second mobile terminal in a region corresponding to the position information. The content selection unit to select a content based on the received playlist information. The recommendation information transmission unit transmits recommendation information about the selected content to the first mobile terminal.

Exemplary embodiments of present invention also provide a content recommendation system including a request receiving unit, a playlist information receiving unit, and a playlist information transmission unit. The request receiving unit receives a content recommendation request including position information from a first mobile terminal. The playlist information receiving unit receives playlist information from at least one second mobile terminal in a region corresponding to the position information. The playlist information transmission unit transmits the received playlist information to the first mobile terminal. The content is recommended based on the transmitted playlist information.

Exemplary embodiments of present invention also provide a mobile system including a verification unit to verify at least one of movement velocity information and weather information, and a content recommendation unit to recommend at least one content based on the verified information.

Exemplary embodiments of present invention also provide a mobile system including an information receiving unit, an information verification unit, a content selection unit, and a recommendation information transmission unit. The information receiving unit receives position information of a mobile terminal. The information verification unit verifies at least one of movement velocity information of the mobile terminal and weather information of a region corresponding to the position information, based on the position information. The content selection unit selects a content based on the verified information. The recommendation information transmission unit to recommend recommendation information about the selected content to the mobile terminal.

Exemplary embodiments of present invention also provide a content recommendation method including receiving playlist information of a mobile terminal based on at least one of a current position of the mobile terminal and a set position, and recommending a content to the mobile terminal based on the received playlist information.

Exemplary embodiments of present invention also provide a content recommendation method including transmitting, to a content recommendation server, information about at least one position of a current position of a mobile system and a set position, receiving recommendation information from the content recommendation server, and recommending at least one content to the user based on the recommendation information. The recommendation information is generated by the content recommendation server based on playlist information of another mobile system in a region corresponding to the at least one position.

Exemplary embodiments of present invention also provide a content recommendation method including receiving a content recommendation request comprising position information from a first mobile terminal, receiving playlist information from at least one second mobile terminal in a region corresponding to the position information, selecting at least one content based on the received playlist information, and transmitting recommendation information corresponding to the selected at least one content to the first mobile terminal.

Exemplary embodiments of present invention also provide a content recommendation method including receiving, from a first mobile terminal, a content recommendation request comprising position information of a first mobile terminal, receiving playlist information from at least one second mobile terminal in a region corresponding to the position information, and transmitting the received playlist information to the first mobile terminal. At least one content is recommended to the first mobile terminal based on the transmitted playlist information.

Exemplary embodiments of present invention also provide a content recommendation method including verifying at least one of movement velocity information and weather information, and recommending at least one content based on the verified information.

Exemplary embodiments of present invention also provide a content recommendation method including receiving position information of a mobile terminal, verifying at least one of movement velocity information of the mobile terminal and weather information of a region corresponding to the position information, based on the position information, selecting at least one content based on the verified information, and transmitting, to the mobile terminal, recommendation information about the selected at least one content.

Additional features of the invention will be set forth in the description which follows, and in part will be apparent from the description, or may be learned by practice of the invention.

### BRIEF DESCRIPTION OF THE DRAWINGS

The accompanying drawings, which are included to provide a further understanding of the invention and are incorporated in and constitute a part of this specification, illustrate exemplary embodiments of the present invention, and together with the description serve to explain the principles of the invention.

FIG. 1 is a block diagram illustrating a relationship between a mobile system and a content providing system according to exemplary embodiments of the present invention.

FIG. 2 is a block diagram illustrating an internal configuration of a mobile system using playlist information of other users according to exemplary embodiments of the present invention.

FIG. 3 is a block diagram illustrating an internal configuration of a content recommendation system that may provide playlist information of other users according to exemplary embodiments of the present invention.

FIG. 4 is a block diagram illustrating an internal configuration of a content recommendation system that may recommend contents based on playlist information of other users according to exemplary embodiments of the present invention.

FIG. 5 is a block diagram illustrating an internal configuration of a mobile system using movement velocity information of weather information according to exemplary embodiments of the present invention.

FIG. 6 is a block diagram illustrating an internal configuration of a content recommendation system using movement velocity information or weather information according to exemplary embodiments of the present invention.

FIG. 7 is a flowchart illustrating a content recommendation method that may recommend contents using playlist information of other users according to exemplary embodiments of the present invention.

FIG. 8 is a flowchart illustrating a content recommendation method that may transmit playlist information of other users according to exemplary embodiments of the present invention.

FIG. 9 is a flowchart illustrating a content recommendation method that may recommend contents using recommendation information in accordance with playlist information of another according to exemplary embodiments of the present invention.

FIG. 10 is a flowchart illustrating a content recommendation method that may transmit recommendation information in accordance with playlist information of another user according to exemplary embodiments of the present invention.

FIG. 11 is a flowchart illustrating a content recommendation method that may recommend contents using movement velocity information or weather information according to exemplary embodiments of the present invention.

FIG. 12 is a flowchart illustrating a content recommendation method that may transmit movement velocity information or weather information according to exemplary embodiments of the present invention.

FIG. 13 is a flowchart illustrating a content recommendation method that may recommend contents using recommendation information in accordance with movement velocity information or weather information according to exemplary embodiments of the present invention.

FIG. 14 is a flowchart illustrating a content recommendation method that may transmit recommendation information in accordance with movement velocity information or weather information according to exemplary embodiments of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements. Detailed descriptions of well-known functions and structures incorporated herein may be omitted to avoid obscuring the subject matter of the present invention. It will be understood that for the purposes of this disclosure, “at least one of” can be interpreted to mean any combination the enumerated elements following the respective language, including combination of multiples of the enumerated elements. For example, “at least one of X, Y, and Z” will be construed to mean X only, Y only, Z only, or any combination of two or more.

It will be understood that, although the terms first, second, third etc. may be used herein to describe various elements, components, regions, layers and or sections, these elements, components, regions, layers and or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and or “comprising,” when used in this specification, specify the presence of stated features, integers, steps, operations, elements, and or components, but do not preclude the presence or addition of one or more other features, integers, steps, operations, elements, components, and or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning For example consistent with their meaning in the context of the relevant art and will not be interpreted in an idealized or overly formal sense unless expressly so defined herein.

Hereinafter, exemplary embodiments of the present invention will be described in detail with reference to the accompanying drawings.

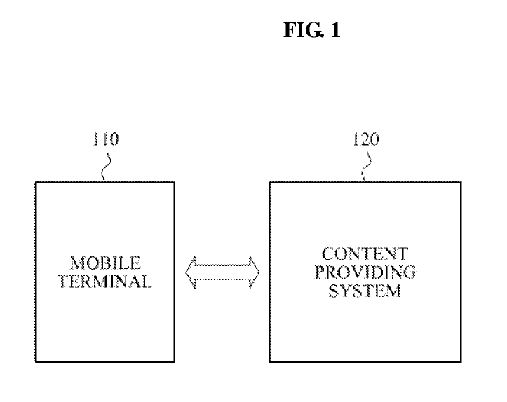

FIG. 1 is a diagram illustrating a mobile system 110 and a content providing system 120.

The mobile system 110 may transmit, to the content providing system 120, position information such as a current position or a position as set by a user, and the content providing system 120 may transmit information corresponding to the received position information to the mobile system 110.

The content providing system 120 may transmit information as the basis for recommending contents to the mobile system 110 using the position information and may determine contents to be recommended using the received information from the mobile system 110 to thereby recommend the determined contents to a user.

In some cases, the content providing system 120 may determine contents selected based on the position information as contents desired to be recommended to the user, and may then transmit recommendation information with respect to the determined contents to the mobile system 110. The mobile system 110 may directly recommend the contents received from the content providing system 120 in accordance with the recommendation information to the user.

The contents desired to be recommended to the user may be determined, for example, in the mobile system 110 or in the content providing system 120.

The position information may include information about a position of the mobile system 110 and a position set by the user of the mobile system 110. In some cases, the current position of the mobile system 110 may be directly calculated in the mobile system 110 using satellite navigation equipment, or calculated through a separate position measurement server.

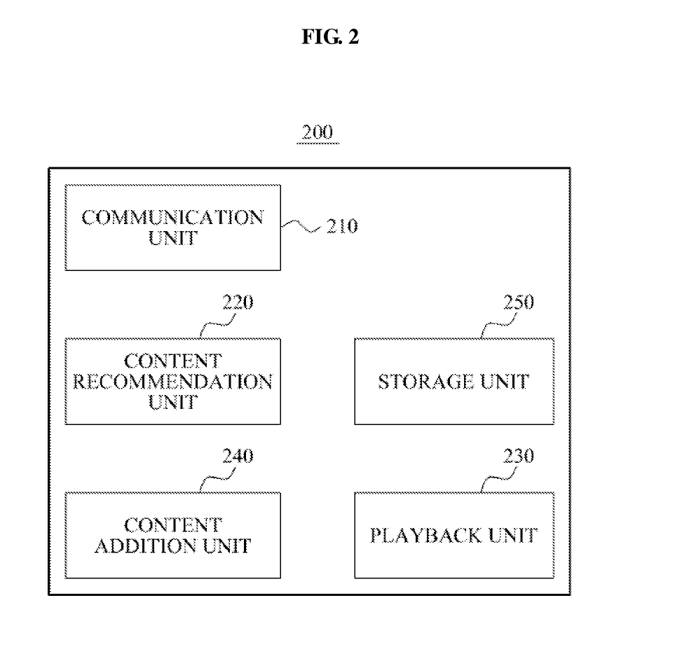

FIG. 2 is a block diagram illustrating an internal configuration of a mobile system 200. The mobile system 200 may correspond to the mobile system 110 of FIG. 1, and may include a communication unit 210, a content recommendation unit 220, a playback unit 230, a content addition unit 240, and a storage unit 250, as illustrated in FIG. 2.

The communication unit 210 may receive playlist information of another user based on at least one of a current position of the mobile system 200 and a position set by a user. The playlist information of the other user may include at least one of information about contents currently being played in a mobile system of the other user, and information about contents selected by the other user and waiting to be played.

The playlist information of the other user may include, but is not limited to, information about music contents being played using the mobile system of the other user, and/or information about a playlist of music contents set in the mobile system of the other user. For example, the playlist information of the other user may include information about movie contents played using the mobile system of the other user.

The communication unit 210 may receive the playlist information based on a current position of the mobile system 200 or a position set using the mobile system 200 by a user. The communication unit 210 may include a transmission unit (not illustrated) to transmit, to a predetermined destination (e.g., server), the playlist information of the user and information about the current position of the mobile system 200, and a receiving unit (not illustrated) to receive the playlist information of the other user from a predetermined location (e.g., server). The server may correspond to the content providing system 120 of FIG. 1. Each of a plurality of mobile systems including the mobile system 200 may transmit its own playlist information and the information about the current position to the content providing system 120. Furthermore, each of the plurality of mobile systems may receive the playlist information transmitted to the content providing system 120 from another mobile system.

The playlist information received by the receiving unit (not illustrated) may include at least one of playlist information transmitted to the predetermined destination (e.g., server) from a mobile system existing in a region corresponding to at least one position. For example, the communication unit 210 may receive, through the content providing system 120, playlist information of mobile systems existing in a region corresponding to the current position of the mobile system 200. The playlist information of mobile systems may include information about contents that are being played in the mobile systems existing around the mobile system 200 may be obtained.

The content recommendation unit 220 may recommend contents based on the received playlist information. For example, the content recommendation unit 220 may recommend contents to a user based on information about the contents that are played in the mobile systems existing around the mobile system 200 or in the mobile systems existing in a region corresponding to a position set by a user.

The content recommendation unit 220 may select and recommend a predetermined number of contents in any suitable order. For example, the content recommendation unit 220 may select and recommend the predetermined number of contents in descending order of a number of times contents are repeatedly included in the received playlist information. The user may play the recommended contents together with contents such as music or movies which other users around the user are enjoying. For example, in some cases, music which the other users around the user are listening to or desire to listen to may be recommended to a user who does not know what genre of music the user should listen to, to a user having difficulties selecting music, or to a user being irritated with a selection of media content, so that opportunities to share new media may be provided.

The communication unit 210 may receive play information and position information of another user. For example, the content recommendation unit 220 may display contents to be recommended using a geometric graphic based on position information of another user. The geometric graphic in which a current position of the mobile system 200 is displayed. Contents being used by another user relatively close to a corresponding user may be displayed as being relatively closer to a position where the current position of the mobile system 200 is displayed. Contents being used by another user relatively distant from the corresponding user may be displayed as being relatively distant from the position where the current position of the mobile system 200 is displayed. To generate the geometric graphic, a calculation geometric algorithm such as, for example, a sweep line algorithm may be used.

The playback unit 230 may play contents selected by a user among the recommended contents. For example, when the contents are selected by the user from among the contents recommended by the content recommendation unit 220, the playback unit 230 may play the selected contents.

The content addition unit 240 may add, to the playlist information of the user, the contents selected by the user among the recommended contents. For example, when the selected contents are music contents, and the user is listening to other music contents, the selected music contents may be added to a playlist, so that the playback unit 230 may play music contents in accordance with the playlist.

The storage unit 250 may store a file with respect to at least one of contents. The playback unit 230 may play the selected contents using the stored file. For example, when the file with respect to the contents selected by the user among the recommended contents does not exist in the storage unit 250, the communication unit 210 may receive the selected contents in a file scheme or in a streaming scheme, and the playback unit 230 may play the contents selected through the received file, or play the contents received in the streaming scheme. The contents in the file and streaming scheme may be received through the content providing system 120, or through a separate linked system.

In some cases, the mobile system 200 may correspond to the mobile system 110 of FIG. 1. In such cases, the mobile system 200 may include the communication unit 210, the content recommendation unit 220, the playback unit 230, the content addition unit 240, and the storage unit 250, as illustrated in FIG. 2.

The communication unit 210 may transmit, to a content recommendation server, information about at least one of a current position of the mobile system 200 and a position set by a user, and may receive recommendation information about the contents from the content recommendation server. The content recommendation server may correspond to the content providing system 120 of FIG. 1. In some cases, based on playlist information of another mobile system existing in a region corresponding to the at least one position, the recommendation information may be generated by the content recommendation server. For example, when the communication unit 210 transmits information about a position to the content recommendation server, the content recommendation server may receive playlist information from mobile systems existing in the region corresponding to the position and may select contents to be recommended through the received play information. The content recommendation server may transmit, to the mobile system 200, the recommendation information about the contents to be recommended, and the mobile system 200 may receive the recommendation information through the communication unit 210.

The content recommendation unit 220 may recommend at least one of the contents to a user based on the recommendation information. For example, the mobile system 200 may transmit position information to the content recommendation server and may determine the contents to be recommended through playlist information of other mobile systems in accordance with the position information. When the content recommendation server transmits, to the mobile system 200, the recommendation information, the mobile system 200 may recommend the contents depending on the recommendation information to the user. Accordingly, contents which other users are listening to in a region corresponding to a current position of the mobile system 200 or a position set by the user may be recommended to the user. When the content recommendation server receives the playlist information from the mobile terminals existing in the region corresponding to the current position of the mobile system 200 and selects contents being most frequently played through the playlist information, contents being most frequently played by other users around a corresponding user may be recommended to the corresponding user.

Descriptions of the playback unit 230, the content addition unit 240, and the storage unit 250 will be omitted for conciseness so as not to be repetitive with the disclosure hereinabove.

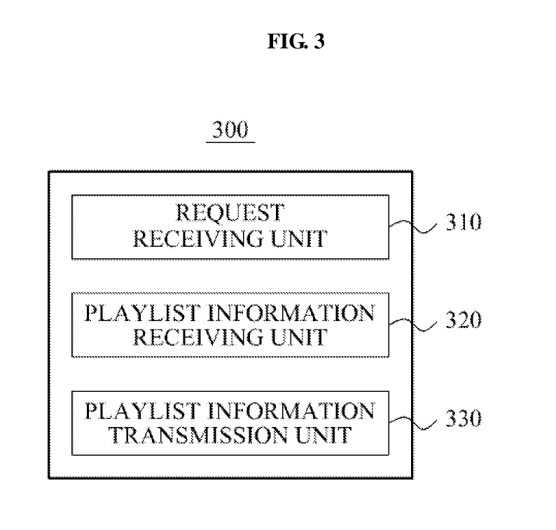

FIG. 3 is a block diagram illustrating an internal configuration of a content recommendation system 300 that may provide play information of other users according to exemplary embodiments of the present invention. The recommendation system 300 may correspond to the content providing system 120 described with reference to FIG. 1. The content recommendation system 300 may include a request receiving unit 310, a playlist information receiving unit 320, and a playlist information transmission unit 330, as illustrated in FIG. 3.

The request receiving unit 310 may receive, from a first mobile terminal, a content recommendation request including position information. The position information may include information about at least one of a current position of the first mobile terminal and a position set by a user of the first mobile terminal.

The playlist information receiving unit 320 may receive playlist information from a second mobile terminal in a region corresponding to the position information. The playlist information receiving unit 320 may determine whether the second mobile terminal is in the region corresponding to the position information based on a current position of the second mobile terminal. For example, the playlist information receiving unit 320 may receive playlist information from the second mobile terminal in a region corresponding to the current position of the first mobile terminal or a position set by a user of the first mobile terminal. Each of the first and second mobile terminals may correspond to the mobile system 110 described with reference to FIG. 1 or the mobile system 200 described with reference to FIG. 2.

The playlist information transmission unit 330 may transmit the received playlist information to the first mobile terminal.

In some cases, contents may be recommended to a user of the first mobile terminal based on the transmitted playlist information. For example, when the first mobile terminal transmits the position information and a content recommendation request to the content recommendation system 300, the content recommendation system 300 may receive playlist information from the second mobile terminals in a region corresponding to the received position information, and may transmit the received playlist information to the first mobile terminal. The playlist information may include at least one of information about contents being currently played in the second mobile terminal and information about contents selected by the user of the second mobile terminal and waiting to be played. For example, the first terminal may receive a recommendation for contents being currently played or waiting to be played in the second mobile terminal through the playlist information. When the position information provided from the first mobile terminal is information about the current position of the first mobile terminal, and the recommended contents are music contents, the user of the first mobile terminal may receive a recommendation for music contents which other users are listening to or for music contents waiting to be played.

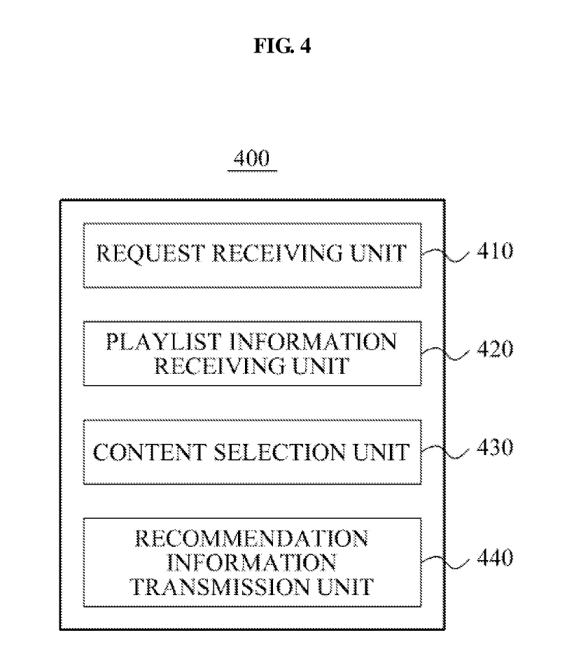

FIG. 4 is a block diagram illustrating an internal configuration of a content recommendation system 400 that may recommend contents based on playlist information of other users according to exemplary embodiments of the present invention.

The content recommendation system 400 may correspond to the content providing system 120 described with reference to FIG. 1 or the content recommendation server described with reference to FIG. 2. The content recommendation system 400 may include a request receiving unit 410, a playlist information receiving unit 420, a content selection unit 430, and a recommendation information transmission unit 440, as illustrated in FIG. 4.

The request receiving unit 410 may receive, from the first mobile terminal, a content recommendation request including position information of the first mobile terminal. The position information may include information about at least one of a current position of the first mobile terminal and a position set by the user of the first mobile terminal.

The playlist information receiving unit 420 may receive playlist information from a second mobile terminal in a region corresponding to the position information. The playlist information receiving unit 420 may determine whether the second mobile terminal is in the region based on a current position of the second mobile terminal. For example, the playlist information receiving unit 430 may receive the playlist information from the second mobile terminal in a region corresponding to the current position of the first mobile terminal or a position set by a user of the first mobile terminal. Each of the first and second mobile terminals may correspond to the mobile system 110 of FIG. 1 and the mobile system 200 of FIG. 2.

The content selection unit 430 may select contents based on the received playlist information. For example, the content selection unit 430 may select contents to be recommended to the user of the first mobile terminal based on information about contents being played in the mobile terminals existing around the first mobile terminal or existing in a specific region.

The recommendation information transmission unit 440 may transmit recommendation information about the selected contents to the first mobile terminal. The contents may be played in the first mobile terminal based on the recommendation information, or contents corresponding to the recommendation information may be added to the playlist information of the first mobile terminal.

The content selection unit 430 may select a predetermined number of contents in any suitable order. For example, the content selection unit 430 may select a predetermined number of contents in a descending order of a number of times the contents are repeatedly included in the received playlist information, and the recommendation information transmission unit 440 may generate recommendation information about the selected contents, and transmit the generated information to the first mobile terminal. The first mobile terminal may play contents based on the recommendation information or add corresponding contents to the recommendation information so that the user may play contents, such as music or movies, which other users around the user or other users in a region are enjoying.

Thus, music which other users around the user are listening to or desire to listen to may be recommended to a user who does not know what genre of music the user should listen to, to a user having difficulties selecting music, or to a user being irritated with a selection of media content, so that opportunities to share new media may be provided.

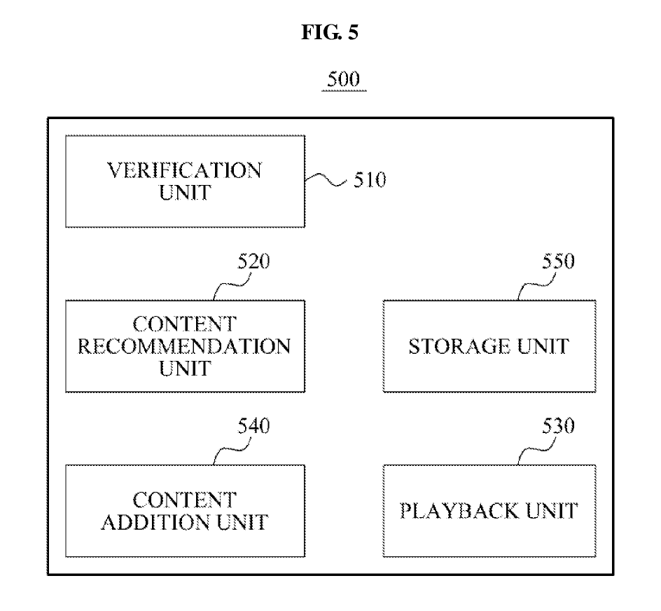

FIG. 5 is a block diagram illustrating an internal configuration of a mobile system 500 using movement velocity information of weather information according to exemplary embodiments of the present invention. The mobile system 500 may include a verification unit 510, a content recommendation unit 520, a playback unit 530, a content addition unit 540, and a storage unit 550, as illustrated in FIG. 5.

The mobile system 500 may correspond to the mobile system 110 described with reference to FIG. 1.

The verification unit 510 may verify at least one of movement velocity information and weather information. For example, the mobile system 500 may transmit information about a current position to the content providing system 120 of FIG. 1, and the content providing system 120 may generate information on the at least one of the movement velocity information and the weather information, which may be generated based on the information about the current position of the mobile system 500. The content providing system 120 may transmit the generated information to the mobile system 500. The content providing system 120 may receive position information of the mobile system 500, verify the information of movement velocity information of the mobile system 500 and weather information of a region corresponding to the position information based on the position information of the mobile system, and may then transmit the verified information to the mobile system 500.

In some cases, the verification unit 510 may verify the at least one information of the movement velocity information and the weather information without using the content providing system 120. For example, when the mobile system 500 includes satellite navigation equipment, the mobile system 500 may measure a position at regular time intervals using the satellite navigation equipment, thereby obtaining a moved distance and a time for traveling the moved distance. The verification unit 510 may calculate movement velocity information through a calculation performed between the obtained distance and the time. In addition, when the mobile system 500 does not include satellite navigation equipment, the verification unit 510 may obtain position information using a separate position tracking server to thereby calculate the movement velocity information. In addition, the verification unit 510 may obtain weather information of a region corresponding to the current position using a separate server (e.g., different from the content providing system 120) for providing weather information for each region.

The content recommendation unit 520 may recommend contents based on the verified at least one information. For example, the contents may include music. The content recommendation unit 520 may therefore select a content based on at least one of a beat, a mood, a title, and lyrics of the music, and based on the movement velocity information or the weather information, may recommend the selected contents to the user. For example, contents including music having a beat suitable for a current movement velocity may be recommended to the user by comparing the beat of the music and the movement velocity information. In some cases, when the mobile station 500 is in area experiencing rain, contents including music having rain-related lyrics may be recommended to the user based on the weather information.

Other than the contents including music, contents in which a number of operations of the mobile system 500 is relatively small may be provided when the movement velocity is fast and contents in which the number of operations of the mobile system 500 is relatively large may be provided when the movement velocity is slow. For example, in some cases, action role-playing games (RPG) in which a number of operations is relatively large may be recommended as a content when the movement velocity is relatively slow. In some cases, strategy simulation games performed in a turn scheme may be recommended as the content when the movement velocity is relatively fast.

The playback unit 530, the content addition unit 540, and the storage unit 550 may be operated in the same manner as the playback unit 230, the content addition unit 240, and the storage unit 250 described with reference to FIG. 2. Detailed descriptions of the playback unit 230, the content addition unit 240, and the storage unit 250 will be omitted for conciseness and to avoid repetition.

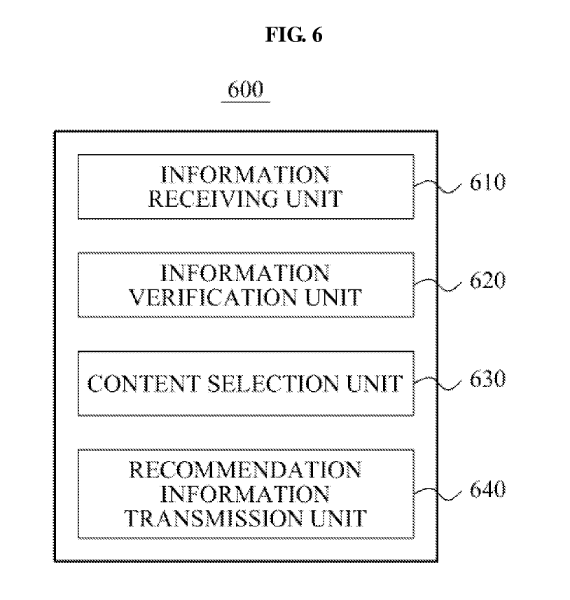

FIG. 6 is a block diagram illustrating an internal configuration of a content recommendation system 600 using movement velocity information or weather information according to exemplary embodiments of the invention. The content recommendation system 600 may correspond to the content providing system 120 of FIG. 1. As illustrated in FIG. 6, the content recommendation system 600 may include an information receiving unit 610, an information verification unit 620, a content selection unit 630, and a recommendation information transmission unit 640.

The information receiving unit 610 may receive position information of a mobile terminal. The mobile terminal may correspond to the mobile system 110 of FIG. 1. The position information may include information about a current position of the mobile terminal. The position information of the mobile terminal may be received from the mobile terminal or may be received through a separate position tracking server.

The information verification unit 620 may verify at least one of movement velocity information of the mobile terminal and weather information of a region corresponding to the position information, based on the position information. For example, the information verification unit 620 may calculate the movement velocity information of the mobile terminal using a distance and a time for traveling the distance which are verified through the received position information of the mobile terminal at regular time intervals through the information receiving unit 610. In addition, weather information of the region corresponding to the position information of the mobile terminal may be obtained in conjunction with a separate server providing weather information for each region.

The content selection unit 630 may select contents based on the verified at least one information. For example, the contents may include music. In some cases, the content recommendation unit 520 may select contents based on at least one of a beat, a mood, a title, and lyrics of music, and based on the movement velocity information or the weather information, and may recommend the selected contents to the user. For example, contents including music having a beat suitable for a current movement velocity may be recommended to the user by comparing the movement velocity information and the beat of the music. In some cases, when the mobile terminal is in area experiencing rain, contents including music having rain-related lyrics may be recommended to the user using the weather information.

The recommendation information transmission unit 640 may transmit recommendation information about the selected contents to the mobile terminal. In some cases, contents may be played in the mobile terminal based on the recommendation information. In some cases, contents corresponding to the recommendation information may be added to play information of the mobile terminal.

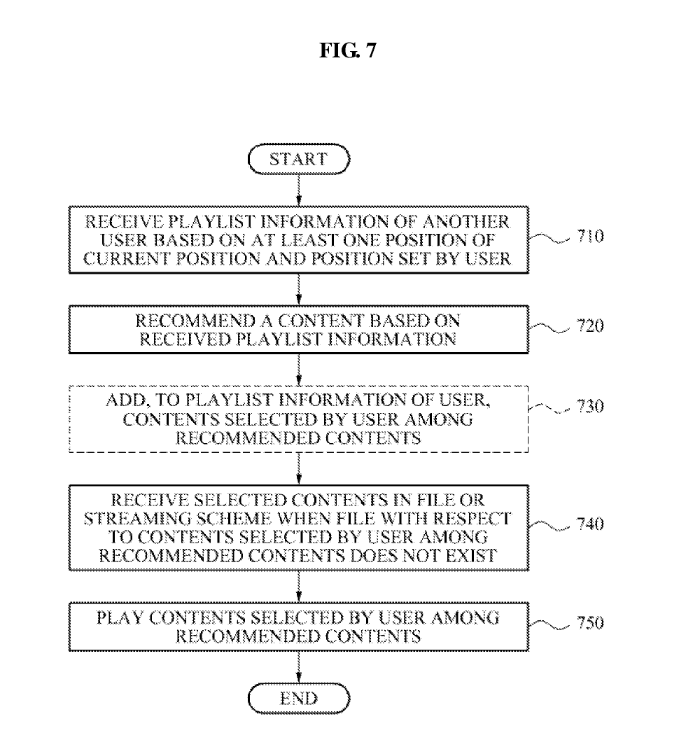

FIG. 7 is a flowchart illustrating a content recommendation method that may recommend contents using playlist information of other users according to exemplary embodiments of the present invention. The content recommendation method may be performed by the mobile system 200 of FIG. 2.

In 710, the mobile system 200 may receive playlist information of another user based on at least one of a current position of the mobile system 200 and a position set by a user. The playlist information of the other user may include at least one of information about contents being currently played in a mobile system of the other user or information about contents selected by the other user and waiting to be played.

For example, the playlist information of the other user may include information about music contents being currently played through the mobile system of the other user or information about a playlist of the music contents set in the mobile system of the other user. In some cases, the playlist information of the other user may include information about movie contents being currently being played in the mobile system of the other user.

As noted above, the mobile system 200 may receive the playlist information based on a current position of the mobile system 200 or a position set by the user through the mobile system 200. To achieve this, the mobile system 200 may transmit the playlist information of the user and information about the current position to a predetermined destination (e.g., server), and may receive the play information of the other user from the predetermined destination. In some cases, the predetermined destination (e.g., server) may correspond to the content providing system 120 of FIG. 1 or the content recommendation system 300 of FIG. 3. Each of a plurality of mobile systems, including the mobile system 200, may transmit, to system 120 or 300, its own playlist information and the information about its current position. In addition, each of the plurality of mobile systems may receive the play information transmitted to system 120 or 300 from another mobile system.

The playlist information transmitted to the mobile system 200 may include a playlist information transmitted to a predetermined server from a mobile system existing in a region corresponding to the at least one position. For example, the mobile system 200 may receive the playlist information of the mobile systems existing in the region corresponding to the current position of the mobile system 200 through system 120 or 300.

In 720, the mobile system 200 may recommend a content based on the received playlist information. For example, the mobile system 200 may recommend a content to the user based on information about contents being played in the mobile systems existing around the mobile system 200 or in the mobile systems existing in a region corresponding to the position set by the user.

The mobile system 200 may select a predetermined number of contents in any suitable order. For example, the mobile system 200 may select a predetermined number of contents in a descending order of a number of times the contents are repeatedly included in the received playlist information. The mobile system 200 may then recommend the selected contents. The user may play the recommended contents together with contents such as music or movie which other users around the user are listening or watching. For example, music which the other users around the user are listening to or desire to listen to, may be recommended to a user who does not know what genre of music the user should listen to, to a user having difficulties selecting music, or to a user being irritated with a selection of media content, so that opportunities to share new music may be provided.

In 720, the mobile system 200 may receive both playlist information and position information of another user. The mobile system 200 may display contents to be recommended using a geometric graphic based on position information of another user. The geometric graphic in which a current position of the mobile system 200 may be displayed. Contents being used by another user relatively close to a corresponding user may be displayed as being relatively close to a position where the current position is displayed. Contents being used by another user relatively distant from the corresponding user may be displayed as being relatively distant from the position where the current position of the mobile system 200 is displayed. To generate the geometric graphic, a calculation geometric algorithm, such as, for example, a sweep line algorithm may be used.

In 730, the mobile system 200 may add, to playlist information of the user, the contents selected by the user among the recommended contents. For example, when the selected contents are music contents, and the user is listening to other music contents, the mobile system 200 may play the music contents in accordance with the playlist in operation 730 by adding the selected music contents to a playlist.

In 740, the mobile system 200 may store a file with respect to at least one of recommended contents. When the file with respect to at least one of the contents selected by the user does not exist, the mobile system 200 may receive the selected contents in a file scheme or in a streaming scheme. The contents in the file scheme or streaming scheme may be received through system 120 or 300 or may be received through any other suitable system.

In 750, the mobile system 200 may play contents selected by the user among the recommended contents. For example, when the contents are selected by the user from among the recommend contents, the mobile system 200 may play the selected contents in 750. The mobile system 200 may play the contents selected through the received file or may play the contents received in the streaming scheme.

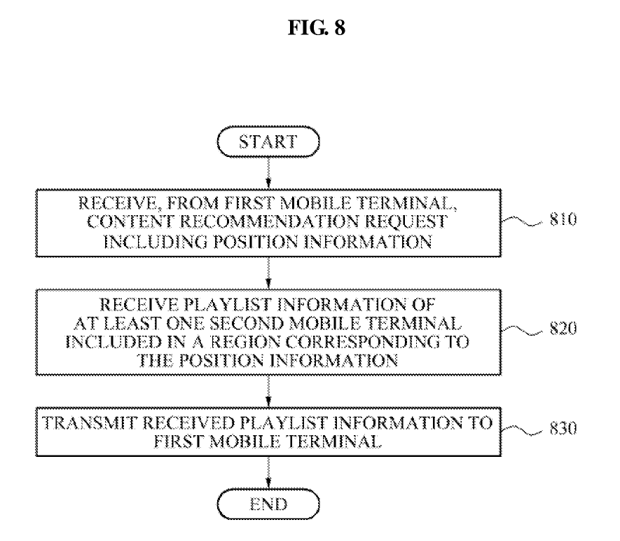

FIG. 8 is a flowchart illustrating a content recommendation method that may transmit play information of other users according to exemplary embodiments of the invention. The content recommendation method of FIG. 8 may be performed by the content recommendation system 300 of FIG. 3.

In 810, the content recommendation system 300 may receive a content recommendation request including position information from a first mobile terminal. The position information may include at least one of a current position of the first mobile terminal and a position set by a user of the first mobile terminal.

In 820, the content recommendation system 300 may receive playlist information of at least one second mobile terminal included in a region corresponding to the position information. The playlist information receiving unit 320 may determine whether the second mobile terminal is in the corresponding region based on a current position of the second mobile terminal. For example, the content recommendation system 300 may receive the playlist information from the second mobile terminal in a region corresponding to the current position of the first mobile terminal or the position set by the user of the first mobile terminal. Each of the first and second mobile terminals may correspond to the mobile system 110 of FIG. 1 and the mobile system 200 of FIG. 2.

In 830, the content recommendation system 300 may transmit the received playlist information to the first mobile terminal. Contents in the first mobile terminal may be recommended to the user based on the transmitted playlist information. For example, when the first mobile terminal transmits the position information and the content recommendation request to the content recommendation system 300, the content recommendation system 300 may receive the play information from the second mobile terminals included in a region corresponding to the received position information, and may transmit the received play information to the first mobile terminal. The playlist information may include at least one of information about contents being currently played in the second mobile system and information about contents selected by a user of the second mobile system and waiting to be played. The contents being played in the second mobile system or the contents waiting to be played may be recommended to the first mobile terminal through the playlist information. When the position information provided from the first mobile terminal is information about the current position of the first terminal and the recommended contents are music contents, music contents which other users around a corresponding user of the first mobile terminal are listening to or music contents waiting to be played may be recommended to the corresponding user of the first mobile terminal.

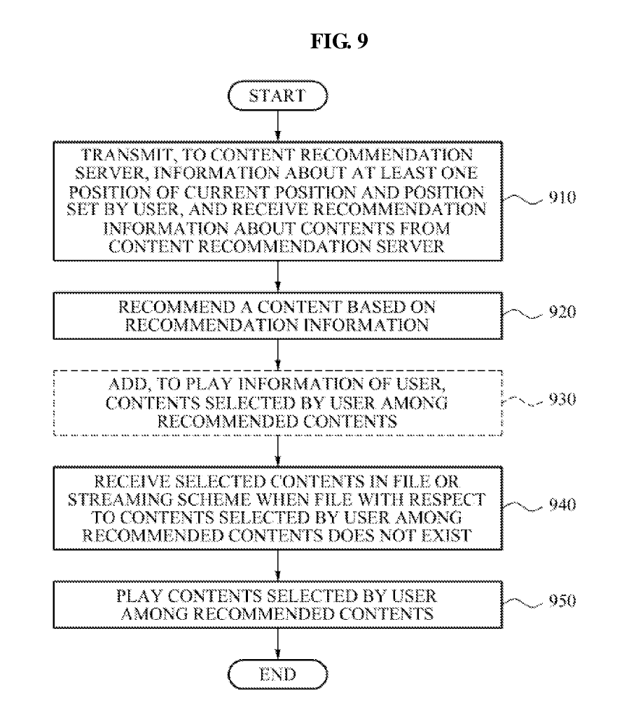

FIG. 9 is a flowchart illustrating a content recommendation method that may recommend contents using recommendation information in accordance with playlist information of another user. The content recommendation method may be performed by the mobile system 200 of FIG. 2.

In 910, the mobile system 200 may transmit, to the content recommendation server, information about at least one of a current position of the mobile system 200 and a position set by the user, and may receive recommendation information about contents from the content recommendation server. The content recommendation server may correspond to the content recommendation system 120 of FIG. 1. The recommendation information may be generated in the content recommendation server based on playlist information of another mobile system existing in a region corresponding to the at least one position. For example, when the communication unit 210 transmits information about the at least one position to the content recommendation server, the content recommendation server may receive the playlist information from the mobile systems in the region corresponding to the at least one position, and may select contents to be recommended through the received playlist information. The content recommendation server may transmit recommendation information about the recommended contents to the mobile system 200, and the mobile system 200 may receive the recommendation information through the communication unit 210.

In 920, the mobile system 200 may recommend a content to the user based on the recommendation information. For example, the mobile system 200 may transmit the position information to the content recommendation server, and the content recommendation server may determine the contents to be recommended through playlist information of other mobile systems which depends on the position information. When the content recommendation server transmits recommendation information to the mobile system 200, the mobile system 200 may recommend the contents depending on the recommendation information to the user. Accordingly, contents which other users are listening to in a region corresponding to a current position or a position set by the user may be recommended to the user. When the content recommendation server receives the playlist information from mobile terminals of a region corresponding to a current position of the mobile system 200 and selects contents being most frequently played through the playlist information, the contents being most frequently played by other users of a corresponding user may be recommended to the corresponding user.

930 to 950 correspond to 730 to 750 of FIG. 7, and thus repeated descriptions thereof will be omitted for conciseness and to avoid repetition.

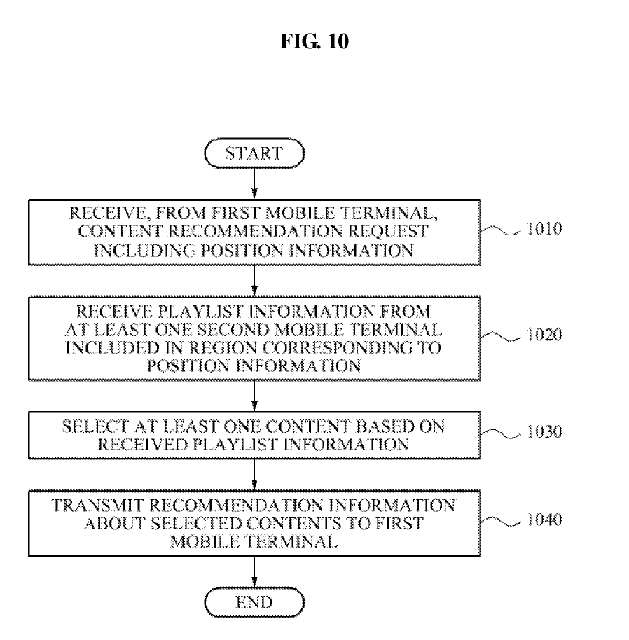

FIG. 10 is a flowchart illustrating a content recommendation method that may transmit recommendation information in accordance with playlist information of another user according to exemplary embodiments of the invention. The content recommendation method may be performed by the content recommendation system 400 of FIG. 4.

In 1010, the content recommendation system 400 may receive a content recommendation request including position information from a first mobile terminal. The position information may include information about at least one of a current position of the first terminal and a position set by a user of the first mobile terminal.

In 1020, the content recommendation system 400 may receive playlist information from at least one second mobile terminal included in a region corresponding to the position information. The content recommendation system 400 may determine whether the second mobile terminal is in the region based on a current position of the second mobile terminal, and the content recommendation system 400 may receive the playlist information from the second mobile terminal determined to be in a region corresponding to the current position of the first mobile terminal or the position set by the user of the first mobile terminal. Each of the first and second mobile terminals may correspond to the mobile system 110 of FIG. 1 and the mobile system 200 of FIG. 2.

In 1030, the content recommendation system 400 may select at least one content based on the received playlist information. For example, the content recommendation system 400 may select contents to be recommended to the user of the first mobile terminal, based on information about contents being played in the second mobile terminals existing around the first mobile terminal or in a specific region.

In 1040, the content recommendation system 400 may transmit recommendation information about the selected contents to the first mobile terminal. The contents may be played in the first mobile terminal based on the recommendation information, or contents corresponding to the recommendation information may be added to the playlist information of the first mobile terminal.

The content recommendation system 400 may select a predetermined number of contents in any suitable order. For example, the content recommendation system 400 may select a predetermined number of contents in a descending order of a number of times the contents are repeatedly included in the received play information and may generate recommendation information about the selected contents to thereby transmit the generated recommendation information to the first mobile terminal. The first mobile terminal may play contents based on the recommendation information, or may add contents corresponding to the recommendation information to the play information so that the user may play contents, such as music or a movie, which other users around the user or other users in a specific region may be listening to or watching.

Thus, music which other users around the user are listening to or desire to listen to may be recommended to a user who does not know what genre of music he should listen to, to a user having difficulties selecting music, or to a user being irritated with a selection of media content, so that opportunities to share new music may be provided.

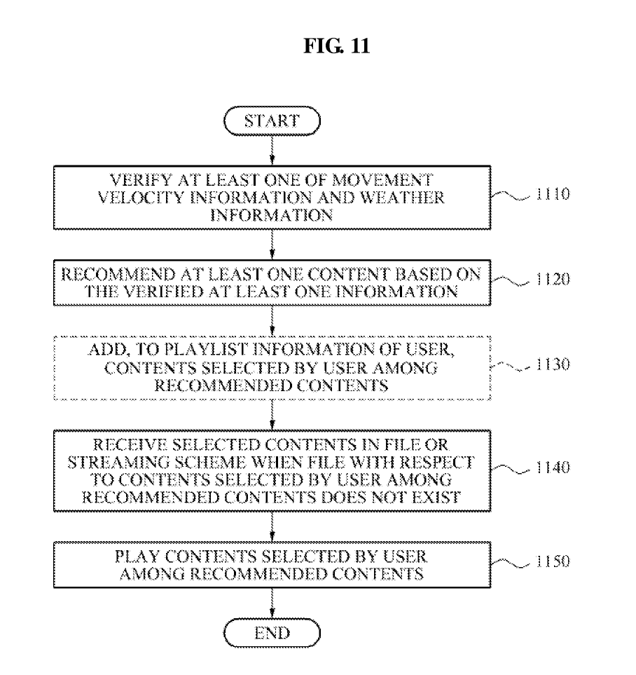

FIG. 11 is a flowchart illustrating a content recommendation method that may recommend contents using movement velocity information or weather information according to exemplary embodiments of the invention. Each operation of the content recommendation method may be performed by the mobile system 500 of FIG. 5.

In 1110, the mobile system 500 may verify at least one of movement velocity information and weather information. For example, the mobile system 500 may transmit information about a current position to the content providing system 120 of FIG. 1, and the content providing system 120 may generate information of the movement velocity information and the weather information based on the information about the current position. The content providing system 120 may then transmit the generated information to the mobile system 500. The content providing system 120 may receive position information of the mobile system 500, and verify at least one information of movement velocity information of the mobile system 500 and weather information of a region corresponding to the position information based on the position information. The content providing system 120 may then transmit the verified information to the mobile system 500.

In some cases, the mobile system 500 may verify at least one of the movement velocity information and the weather information without using the content providing system 120. For example, when the mobile system 500 includes satellite navigation equipment, the mobile system 500 may measure a position at regular time intervals using the satellite navigation equipment, thereby obtaining a moved distance and a time for traveling the moved distance. The mobile system 500 may calculate the movement velocity information through a calculation performed between the obtained distance and time. In addition, if the mobile system 500 does not include satellite navigation equipment, the mobile system 500 may obtain position information using a separate position tracking server to thereby calculate the movement velocity information. In addition, the mobile system 500 may obtain weather information of a region corresponding to the current position using a separate server (different from the content providing system 120) for providing weather information for each region.

In 1120, the mobile system 500 may recommend at least one content based on the verified at least one information. For example, the at least one content may include music. In some cases, the mobile system 500 may select the at least one content based on at least one of a beat, a mood, a title, and lyrics of music, and based on the movement velocity information or the weather information, and may recommend the selected contents to the user. For example, contents including music having beat suitable for a current movement velocity may be recommended to the user. In some cases, when a user of the mobile system 500 is a region with rainy weather, contents including music having rain-related lyrics may be recommended to the user.

In some cases, other than contents including music, contents in which a number of operations of the mobile system 500 is relatively small may be provided when the movement velocity is fast, and contents in which the number of operations of the mobile system 500 is relatively large may be provided when the movement velocity is slow. For example, action RPGs in which a number of operations is relatively large may be recommended when the movement velocity is relatively slow, and strategy simulation games performed in a turn scheme may be recommended when the movement velocity is relatively fast.

1130 to 1150 have been described through 730 to 750 of FIG. 7, and thus repeated descriptions thereof will be omitted for conciseness.

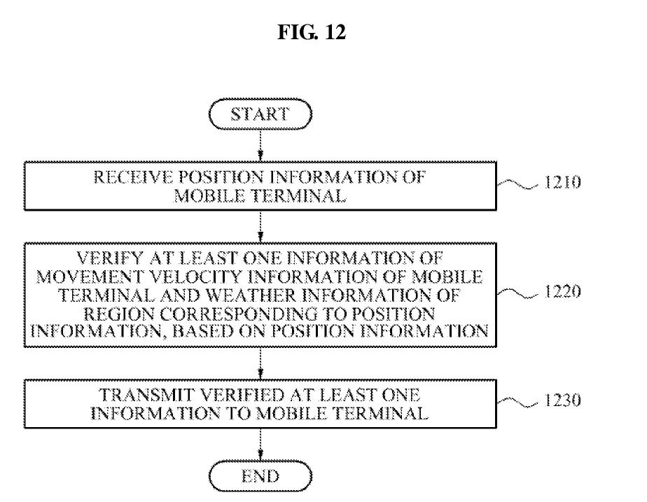

FIG. 12 is a flowchart illustrating a content recommendation method that may transmit movement velocity information or weather information according to exemplary embodiments of the invention. The content recommendation method may be performed by the content recommendation system 120 of FIG. 5.

In 1210, the content providing system 120 may receive position information of a mobile terminal. The mobile terminal may correspond to the mobile system 110 of FIG. 1. In addition, the position information may include information about a current position of the mobile terminal. The position information of the mobile terminal may be received from the mobile terminal or received through a separate position tracking server.

In 1220, the content recommendation system 120 may verify at least one of movement velocity information of the mobile terminal and weather information of a region corresponding to the position information, based on the position information. For example, the content recommendation system 120 may calculate the movement velocity information of the mobile terminal using a distance and a time for traveling the distance which are verified through the received position information of the mobile terminal at regular time intervals. In addition, the weather information of the region corresponding to the position information of the mobile terminal may be obtained in conjunction with a separate server providing weather information for each region.

In 1220, the content recommendation system 120 may transmit the verified at least one information to the mobile terminal. The mobile terminal may receive the at least one information and may select a content based on the received at least one information. In addition, the mobile terminal may recommend the selected contents to the user.

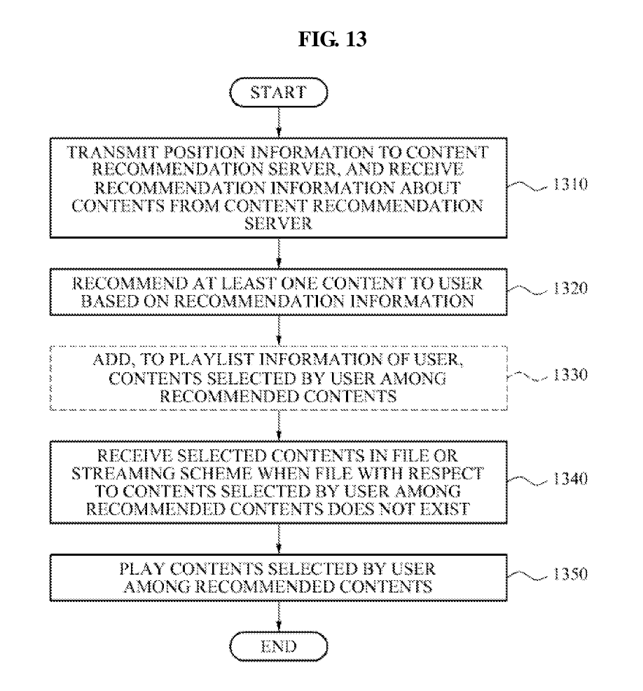

FIG. 13 is a flowchart illustrating a content recommendation method that may recommend contents using recommendation information in accordance with movement velocity information or weather information according to exemplary embodiments of the present invention. The content recommendation method may be performed by the mobile terminal of FIG. 6.

In 1310, the mobile terminal may transmit position information to a content recommendation server, and receive recommendation information about contents from the content recommendation server. The content recommendation server may correspond to the content providing system 120 of FIG. 1. The recommendation information may be generated by the content recommendation server based on playlist information of another mobile system existing in a region corresponding to the position information. For example, when the mobile terminal transmits information about a position to the content recommendation server, the content recommendation server may receive playlist information from mobile systems of the region corresponding to the position information and may select a content to be recommended through the received playlist information. The content recommendation server may transmit, to the mobile terminal, recommendation information about the recommended content and the mobile terminal may receive the recommendation information.

In 1320, the mobile terminal may recommend at least one content to a user based on the recommendation information. For example, the mobile terminal may transmit the position information to the content recommendation server, and the content recommendation server may determine the contents to be recommended through playlist information of other mobile systems. When the content recommendation server transmits the recommendation information to the mobile terminal, the mobile terminal may recommend the contents depending on the recommendation information to the user. Accordingly, contents which other users are listening to in a region corresponding to the current position or the position set by the user may be recommended to the user. When the content recommendation server receives the playlist information from the mobile terminals existing in the region corresponding to the current position of the mobile terminal and selects contents being most frequently played through the playlist information, the contents being most frequently played by other users around the user may be recommended to the user.

1330 to 1350 correspond to 730 to 750 of FIG. 7, and thus repeated descriptions thereof will be omitted for conciseness and to avoid repetition.

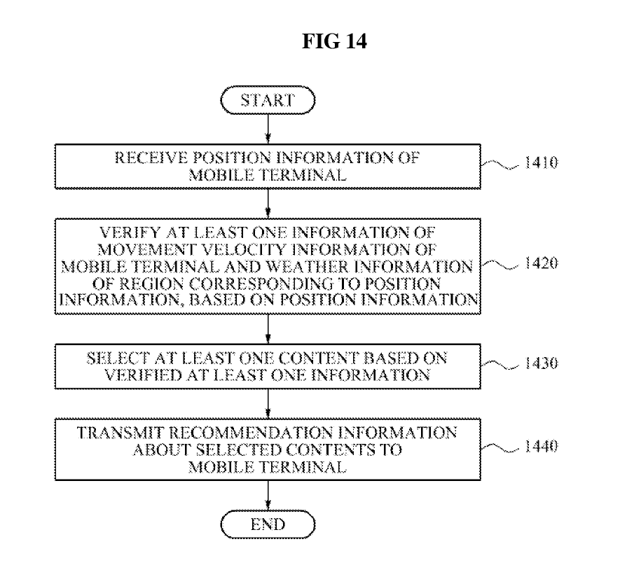

FIG. 14 is a flowchart illustrating a content recommendation method that may transmit recommendation information in accordance with movement velocity information or weather information according to exemplary embodiments of the invention. The content recommendation method may be performed by the content recommendation system 600 of FIG. 6.

In 1410, the content recommendation system 600 may receive position information of a mobile terminal. The mobile terminal may correspond to the mobile system 110 of FIG. 1. In addition, the position information may include information about a current position of the mobile terminal. The position information of the mobile terminal may be received from the mobile terminal or received through a separate position tracking server.

In 1420, the content recommendation system 600 may verify at least one of movement velocity information of the mobile terminal and weather information of a region corresponding to the position information, based on the position information. For example, the content recommendation system 600 may calculate the movement velocity information of the mobile terminal using a distance and a time for traveling the distance which are verified through the received position information of the mobile terminal at regular time intervals. In addition, the weather information of the region corresponding to the position information of the mobile terminal may be obtained in conjunction with a separate server providing weather information for each region.

In 1430, the content recommendation system 600 may select at least one content based on the verified at least one information. For example, the at least one content may include music. The content recommendation system 600 may select the at least one content based on at least one of a beat, a mood, a title, and lyrics of the music and based on the movement velocity information or the weather information, may and recommend the selected contents to the user. For example, contents including music having a beat corresponding to a current movement velocity may be recommended to the user by comparing the movement velocity information and the beat of music. In some cases, when the user is situated in an area experiencing rain, contents including music having rain-related lyrics may be recommended to the user using the weather information.

In 1440, the content recommendation system 600 may transmit recommendation information about the selected contents to the mobile terminal. The contents may be played based on the recommendation information in the mobile terminal. In some cases, contents corresponding to the recommendation information may be added to playlist information of the mobile terminal.

As described above, according to exemplary embodiments, contents may be effectively recommended by providing, to users having difficulties selecting contents or users being irritated with a selection of media, information about the contents based on a movement velocity of the user, weather, or a selection of other users. For example, contents used by other users situated around a corresponding user or existing in a specific region may be recommended to the corresponding user. Contents may be recommended based on a movement velocity of the user or music included in the contents, and contents may be recommended based on an ambient weather of the user.

Exemplary embodiments according to the present invention may be recorded in non-transitory computer-readable media including program instructions to implement various operations embodied by a computer. The non-transitory computer-readable media may include, alone or in combination with the program instructions, data files, data structures, and the like. The media and program instructions may be those specially designed and constructed for the purposes of the present invention or they may be of the kind well-known and available to those having skill in the computer software arts. Examples of non-transitory computer-readable media include magnetic media such as hard disks, floppy disks, and magnetic tape; optical media such as CD ROM discs and DVD; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A mobile system, comprising:
a communication unit to receive first playlist information based on at least one position of a current position of the mobile system and a set position; and
a content recommendation unit to recommend contents based on the received first playlist information.

2. The mobile system of claim 1, wherein
the communication unit comprises a transmission unit to transmit second playlist information and information about the current position to a server, and a receiving unit to receive the first playlist information from the server, and
wherein the first playlist information comprises playlist information received by the server from a second mobile system in a region corresponding to the at least one position.

3. The mobile system of claim 1, wherein the content recommendation unit selects and recommends a number of contents in a descending order of a number of times the contents are repeatedly included in the received first playlist information.

4. The mobile system of claim 1, further comprising:
a playback unit to play selected contents among the recommended contents.

5. The mobile system of claim 1, further comprising:
a content addition unit to add a content, selected from among the recommended contents, to a playlist information of the mobile system.

6. The mobile system of claim 1, further comprising:
a storage unit to store a file corresponding to the recommended contents,
wherein the communication unit receives selected contents from among the recommended contents in a file or streaming scheme in response to a file corresponding to the selected contents not existing in the storage unit.

7. The mobile system of claim 1, wherein the first playlist information comprises at least one of information about contents being played in another mobile system and information about contents in a playlist of the another mobile system and waiting to be played.

8. A mobile system, comprising:
a communication unit to transmit information about at least one position of a current position of the mobile system and a set position to a content recommendation server, and to receive recommendation information from the content recommendation server; and
a content recommendation unit to recommend at least one content based on the recommendation information,
wherein the recommendation information is provided by the content recommendation server based on playlist information of another mobile system in a region corresponding to the at the least one position.

9. A content recommendation system, comprising:
a request receiving unit to receive a content recommendation request comprising position information from a first mobile terminal;
a playlist information receiving unit to receive playlist information from at least one second mobile terminal in a region corresponding to the position information;
a content selection unit to select a content based on the received playlist information; and
a recommendation information transmission unit to transmit recommendation information about the selected content to the first mobile terminal.

10. The content recommendation system of claim 9, wherein the position information comprises at least one of a current position of the first mobile terminal and a set position.

11. The content recommendation system of claim 9, wherein the playlist information receiving unit determines whether the at least one second mobile terminal is in the region.

12. The content recommendation system of claim 9, wherein the content selection unit selects a number of contents in a descending order of a number of times the contents are repeatedly included in the received playlist information.

13. The content recommendation system of claim 9, wherein the content is played in the first mobile terminal based on the recommendation information or the content corresponding to the recommendation information is added to playlist information of the first mobile terminal.

14. The content recommendation system of claim 9, wherein the playlist information comprises at least one of information about contents being played in the second mobile terminal and information about contents in a playlist of the second mobile terminal and waiting to be played.

15. A content recommendation system, comprising:
a request receiving unit to receive a content recommendation request comprising position information from a first mobile terminal;
a playlist information receiving unit to receive playlist information from at least one second mobile terminal in a region corresponding to the position information; and
a playlist information transmission unit to transmit the received playlist information to the first mobile terminal,
wherein a content is recommended based on the transmitted playlist information.

16. A mobile system, comprising:
a verification unit to verify at least one of movement velocity information and weather information; and
a content recommendation unit to recommend at least one content based on the verified information.

17. The mobile system of claim 16, wherein the at least one content comprises music, and the content recommendation unit recommends the at least one content based on at least one of a beat, a mood, and lyrics of the music, and based on the movement velocity information.

18. The mobile system of claim 16, wherein the at least one content comprises music and the content recommendation unit recommends the at least one content based on a beat, a mood and lyrics of the music, and based on the weather information.

19. A content recommendation system, comprising:
an information receiving unit to receive position information of a mobile terminal;
an information verification unit to verify at least one of movement velocity information of the mobile terminal and weather information of a region corresponding to the position information, based on the position information;
a content selection unit to select a content based on the verified information; and
a recommendation information transmission unit to recommend recommendation information about the selected content to the mobile terminal.

20. A content recommendation method, comprising:
receiving playlist information of a mobile terminal based on at least one of a current position of the mobile terminal and a set position; and
recommending a content to the mobile terminal based on the received playlist information.

21. A content recommendation method, comprising:
transmitting, to a content recommendation server, information about at least one position of a current position of a mobile system and a set position;
receiving recommendation information from the content recommendation server; and
recommending at least one content to the user based on the recommendation information,
wherein the recommendation information is generated by the content recommendation server based on playlist information of another mobile system in a region corresponding to the at least one position.

22. A content recommendation method, comprising:
receiving a content recommendation request comprising position information from a first mobile terminal;
receiving playlist information from at least one second mobile terminal in a region corresponding to the position information;
selecting at least one content based on the received playlist information; and
transmitting recommendation information corresponding to the selected at least one content to the first mobile terminal.

23. A content recommendation method, comprising:
receiving, from a first mobile terminal, a content recommendation request comprising position information of a first mobile terminal;
receiving playlist information from at least one second mobile terminal in a region corresponding to the position information; and
transmitting the received playlist information to the first mobile terminal,
wherein at least one content is recommended to the first mobile terminal based on the transmitted playlist information.

24. A content recommendation method, comprising:
verifying at least one of movement velocity information and weather information; and
recommending at least one content based on the verified information.

25. A content recommendation method, comprising:
receiving position information of a mobile terminal;
verifying at least one of movement velocity information of the mobile terminal and weather information of a region corresponding to the position information, based on the position information;
selecting at least one content based on the verified information; and
transmitting, to the mobile terminal, recommendation information about the selected at least one content.

26. A non-transitory computer-readable storage medium comprising executable instructions, which when executed, performs the method of claim 20.
